(19) United States
(12) Patent Application Publication
(10) Pub. No.: US 2015/0350066 A1
(43) Pub. Date: Dec. 3, 2015

(54) APPARATUS AND METHOD FOR TRANSMITTING SATELLITE TELECOMMAND

(71) Applicant: Electronics and Telecommunications Research Institute, Daejeon (KR)

(72) Inventors: In Jun KIM, Daejeon (KR); Byoung Sun LEE, Daejeon (KR)

(21) Appl. No.: 14/484,421

(22) Filed: Sep. 12, 2014

(30) Foreign Application Priority Data
Oct. 4, 2013 (KR) 10-2013-0118810

(51) Int. Cl. H04L 12/703; H04L 12/939

(52) U.S. Cl. CPC H04L 45/28; H04L 49/557

(57) ABSTRACT

An apparatus and a method for transmitting a telecommand to a satellite are disclosed, wherein the satellite telecommand transmitting apparatus may include a transmitter to obtain a telecommand from a transmission command list and transmit the obtained telecommand to a satellite, a verifier to verify whether transmission of the telecommand is successful, and a processor to generate a retransmission telecommand with respect to the telecommand by referring to retransmission information on each telecommand stored in a database and prepare a retransmission command list including the generated retransmission telecommand, when a result of the verifying indicates a failure to transmit the telecommand.

### CROSS-REFERENCE TO RELATED APPLICATION

This application claims the priority benefit of Korean Patent Application No. 10-2013-0118810, filed on Oct. 4, 2013, in the Korean Intellectual Property Office, the disclosure of which is incorporated herein by reference.

### BACKGROUND

1. Field of the Invention

The present invention relates to an apparatus and a method for transmitting a satellite telecommand, and more particularly, for retransmitting a telecommand failed to be transmitted to a satellite.

2. Description of the Related Art

A satellite telecommand transmitting apparatus may transmit a telecommand to a satellite by applying two very distinct methods.

A first transmitting method may include transmitting a telecommand and transmitting a subsequent telecommand after verifying a result of transmitting the first telecommand, which may enable repetitive transmission and verification of telecommands. For example, the satellite telecommand transmitting apparatus to which the first transmitting method is applied may verify whether transmission of the first telecommand is successful after transmitting the first telecommand, and transmit the second telecommand when the transmission of the first telecommand is verified to be successful.

A second transmitting method may include sequentially transmitting all telecommands, irrespective of whether transmission of the all telecommands planned to be transmitted is successful, and retransmitting a telecommand failed to be transmitted after the transmission of all the planned telecommands is completed. In such a transmitting method, transmission and verification may be performed in parallel.

Although transmission of a portion of all the planned telecommands fails, a subsequent telecommand is sequentially transmitted and thus, an operator may not take immediate measures in response to a transmission failure. Also, simply retransmitting the telecommand for which transmission failed may not resolve such an issue. Here, transmission of an additional telecommand may first be required and retransmission of the telecommand may be required in consideration of a characteristic of the telecommand for which transmission failed. Alternatively, retransmission of the telecommand and the additional telecommand may be required.

Accordingly, technology for readily retransmitting a telecommand failed to be transmitted to a satellite may be required.

### SUMMARY

According to exemplary embodiments of the present invention, a retransmission telecommand with respect to a telecommand failed to be transmitted to a satellite may be generated and added to a retransmission command list, and the retransmission telecommand in the retransmission command list may be transmitted after transmission of all telecommands is completed and thus, the telecommand failed to be transmitted to the satellite may be readily retransmitted.

According to exemplary embodiments of the present invention, transmission, verification, and retransmission of a telecommand may be automated by transmitting a telecommand, verifying whether transmission of the telecommand is successful, and generating and transmitting a retransmission telecommand with respect to the telecommand when a result of the verifying indicates a failure to transmit the telecommand. Thus, the telecommand failed to be transmitted to a satellite may be rapidly retransmitted.

According to an aspect of the present invention, there is provided a satellite telecommand transmitting apparatus including a transmitter to obtain a telecommand from a transmission command list and transmit the obtained telecommand to a satellite, a verifier to verify whether transmission of the telecommand is successful, and a processor to generate a retransmission telecommand with respect to the telecommand by referring to retransmission information on each telecommand stored in a database and prepare a retransmission command list including the generated retransmission telecommand, when a result of the verifying indicates a failure to transmit the telecommand.

According to another aspect of the present invention, there is provided a satellite telecommand transmitting method including obtaining a telecommand from a transmission command list and transmitting the obtained telecommand to a satellite, verifying whether transmission of the telecommand is successful, generating a retransmission telecommand with respect to the telecommand by referring to retransmission information on each telecommand stored in a database, when a result of the verifying indicates a failure to transmit the telecommand, and preparing a retransmission command list including the generated retransmission telecommand.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a satellite telecommand transmitting apparatus according to an embodiment of the present invention;

FIG. 2 illustrates retransmission information on each telecommand stored in a database of a satellite telecommand transmitting apparatus according to an embodiment of the present invention;

FIG. 3 illustrates preparation of a retransmission command list of a satellite telecommand transmitting apparatus according to an embodiment of the present invention; and

FIG. 4 is a flowchart illustrating a satellite telecommand transmitting method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

A satellite telecommand transmitting apparatus according to an embodiment of the present invention may be a low earth orbit satellite in a satellite operation environment in which a period of communication time between a satellite and a ground station is relatively short and thus, a maximum number of telecommands may be transmitted within a relatively short period of communication time and thereby, efficiency of satellite operation may be improved. However, the satellite telecommand transmitting apparatus may not be limited thereto. Also, the satellite telecommand transmitting apparatus may be a geostationary satellite in a satellite operation environment in which a period of communication time between a satellite and a ground station is relatively long.

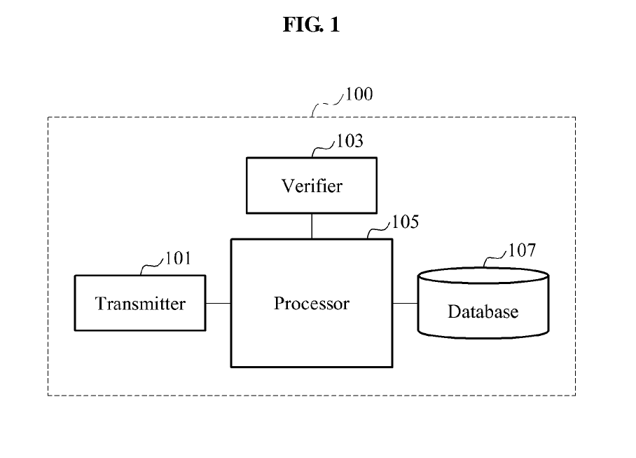

FIG. 1 is a diagram illustrating a configuration of a satellite telecommand transmitting apparatus 100 according to an embodiment of the present invention.

Referring to FIG. 1, the satellite telecommand transmitting apparatus 100 may include a transmitter 101, a verifier 103, a processor 105, and a database 107.

The transmitter 101 may obtain a telecommand from a transmission command list and transmit the obtained telecommand to a satellite. Here, the transmitter 101 may obtain the telecommand in a sequential order of the transmission command list stored in the database 107 and transmit the obtained telecommand to the satellite.

The verifier 103 may verify whether transmission of the telecommand is successful. Here, the verifier 103 may verify whether the transmission of the telecommand is successful based on, for example, verification of a modem/baseband (BB) reply, verification of an increase in a command accept counter, and verification of variation in telemetry data values.

When a result of the verifying indicates a failure to transmit the telecommand, the processor 105 may generate a retransmission telecommand with respect to the telecommand by referring to retransmission information on each telecommand stored in the database 107. Here, the retransmission information on each telecommand may include at least one of telecommand identification information, a type, for example, real time (RT), command, a time tag command, and a priority and transmission time, for example, prior to or subsequent to transmission of a telecommand, of an additional telecommand.

The processor 105 may detect, from the retransmission information on each telecommand, an additional telecommand associated with the telecommand, and generate the retransmission telecommand including the telecommand and the detected additional telecommand. Here, the processor 105 may further detect, from the retransmission information on each telecommand, at least one piece of information on the transmission time of the additional telecommand based on the telecommand and the priority of the additional telecommand, determine a transmission order of the telecommand and the additional telecommand, and generate the retransmission telecommand by arranging the telecommand and the additional telecommand based on the determined transmission order.

When the telecommand or the additional telecommand associated with the telecommand is not detected from the retransmission, the processor 105 may generate the telecommand as the retransmission telecommand. In a case of retransmitting the telecommand, when the additional telecommand to be additionally transmitted along with the telecommand is present, the processor 105 may generate the retransmission telecommand including the telecommand and the additional telecommand. Conversely, when the additional telecommand to be additionally transmitted along with the telecommand is not present, the processor 105 may generate the telecommand as the retransmission telecommand and transmit the telecommand exclusively.

The processor 105 may prepare a retransmission command list including the generated retransmission telecommand and store the retransmission command list in the database 107.

Also, when the type of the telecommand is the real time command, the processor 105 may add the retransmission telecommand with respect to the telecommand to the retransmission command list. Dissimilar to a telecommand of the time tag command type that is received by the satellite, stored in a memory, and implemented at a fixed time, a telecommand of the real time command type may be implemented immediately after the satellite receives the telecommand.

When all telecommands included in the transmission command list are transmitted, the processor 105 may allow the retransmission telecommand included in the retransmission command list to be transmitted to the satellite by the transmitter 101. After transmission of all the telecommands originally desired to be transmitted to the satellite is completed, the processor 105 may refer to the retransmission command list and transmit the retransmission telecommand with respect to a telecommand for which transmission failed.

When transmitting the retransmission telecommand, the processor 105 may allow the telecommand and the additional telecommand included in the retransmission telecommand to be transmitted to the satellite in a sequential order. For example, when a telecommand TC5 is arranged to follow an additional telecommand TC5′, the processor 105 may allow the additional telecommand TC5′ and the telecommand TC5 to be transmitted to the satellite in sequential order.

The database 107 may store at least one of the transmission command list, the retransmission command list, and the retransmission information on each telecommand.

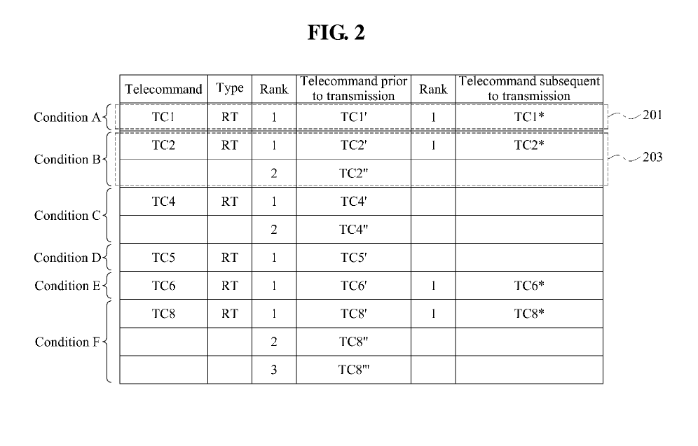

FIG. 2 illustrates retransmission information on each telecommand stored in a database of a satellite telecommand transmitting apparatus according to an embodiment of the present invention.

Referring to FIG. 2, the satellite telecommand transmitting apparatus may store, in the database, the retransmission information on each telecommand including at least one of telecommand identification information, a type command, for example, real time, a time tag command, and a priority and a transmission time of the additional telecommand for example, prior to or subsequent to transmission of a telecommand.

For example, the satellite telecommand transmitting apparatus may store TC1′, an additional telecommand prior to transmitting a telecommand TC1, which is retransmission information 201 corresponding to the telecommand TC1 and the RT command type and has a priority of 1, and TC1*, an additional telecommand subsequent to transmitting the telecommand TC1, which has a priority of 1. (Condition A)

Also, the satellite telecommand transmitting apparatus may store TC2′, an additional telecommand prior to transmitting a telecommand TC2, which is retransmission information 203 corresponding to the telecommand TC2 and the RT command type and has a priority of 1, TC2″, an additional telecommand prior to transmitting the telecommand TC2 having the priority of 2, and TC2*, an additional telecommand subsequent to transmitting the telecommand TC2 having the priority of 1. (Condition B)

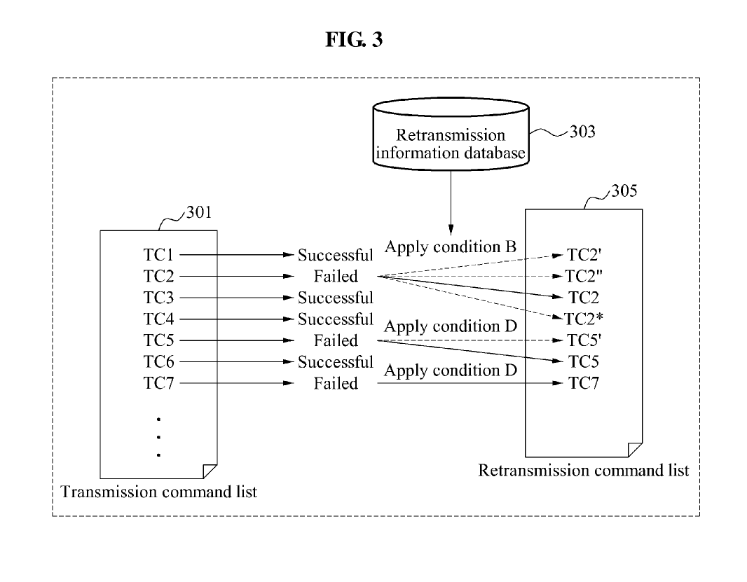

FIG. 3 illustrates preparation of a retransmission command list 305 of a satellite telecommand transmitting apparatus according to an embodiment of the present invention.

Referring to FIG. 3, the satellite telecommand transmitting apparatus may transmit telecommands in an order arranged in a transmission command list 301. For example, the satellite telecommand transmitting apparatus may transmit telecommands, TC1, TC2, TC3, TC4, TC5, TC6, and TC7, based on a sequential order in the transmission command list 301.

Each time the satellite telecommand transmitting apparatus transmits a telecommand, the satellite telecommand transmitting apparatus may verify whether transmission of each telecommand is successful. When the transmission is verified to be a failed attempt, the satellite telecommand transmitting apparatus may refer to retransmission information on each telecommand stored in a database 303, generate a retransmission telecommand with respect to the telecommand, and prepare the retransmission command list 305 including the retransmission telecommand. For example, when transmission of a telecommand TC2 is verified to be a failed attempt, the satellite telecommand transmitting apparatus may refer to the retransmission information, for example, condition B of FIG. 2, corresponding to the telecommand TC2 stored in the database 303, generate a retransmission telecommand including TC2′, TC2″, TC2, and TC2* with respect to the telecommand TC2, and prepare the retransmission command list 305 including the generated retransmission telecommand.

Here, the satellite telecommand transmitting apparatus may detect, from the retransmission information on each telecommand, a transmission time and a priority of an additional telecommand, for example, TC2′, TC2″, and TC2*, based on the telecommand TC2, determine a transmission order of the telecommand and the additional telecommand based on the detected information, arrange TC2′, TC2″, TC2, and TC2* based on the determined transmission order, and generate the retransmission telecommand with respect to the telecommand TC2.

For another example, when transmission of a telecommand TC5 is verified to be a failed attempt, the satellite telecommand transmitting apparatus may refer to the retransmission information, for example, condition D of FIG. 2, corresponding to the telecommand TC5 stored in the database 303, generate a retransmission telecommand including TC5′ and TC5 as the retransmission telecommand with respect to the telecommand TC5, and upgrade the retransmission command list 305 to include the generated retransmission telecommand.

Also, when transmission of a telecommand TC7 is verified to be a failed attempt, the satellite telecommand transmitting apparatus may refer to the retransmission information on each telecommand of FIG. 2 stored in the database 303. Here, when the retransmission information on the telecommand TC7 is not found in the retransmission information on each telecommand, the satellite telecommand transmitting apparatus may generate a retransmission telecommand including the telecommand TC7 as the retransmission telecommand of the telecommand TC7, and upgrade the retransmission command list 305 to include the generated retransmission telecommand.

When all telecommands, for example, TC1, TC2, TC3, TC4, TC5, TC6, and TC7, included in the transmission command list 301 are transmitted, the satellite telecommand transmitting apparatus may transmit a retransmission telecommand included in the retransmission command list 305. Here, the satellite telecommand transmitting apparatus may transmit, to the satellite, telecommands TC2′, TC2″, TC2, TC2*, TC5′, TC5, and TC7 in sequential order arranged in the retransmission command list 305.

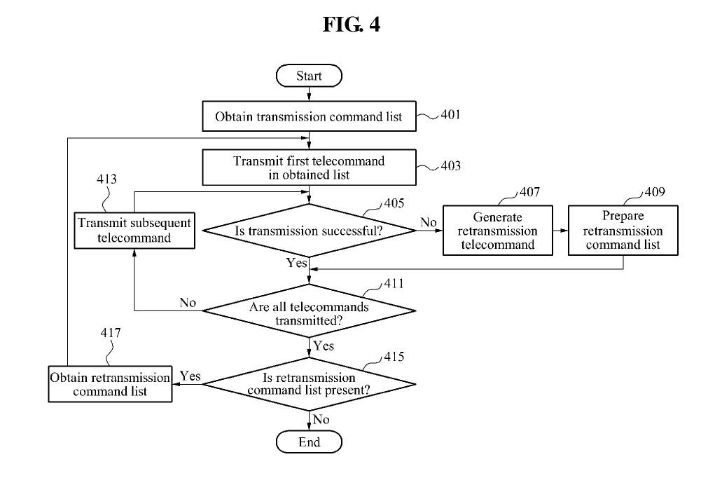

FIG. 4 is a flowchart illustrating a satellite telecommand transmitting method according to an embodiment of the present invention.

Referring to FIG. 4, in operation 401, a satellite telecommand transmitting apparatus may obtain a transmission command list stored in a database.

In operation 403, the satellite telecommand transmitting apparatus may obtain a first telecommand from the transmission command list and transmit the obtained telecommand to a satellite.

In operation 405, the satellite telecommand transmitting apparatus may verify whether transmission of the telecommand is successful.

When the transmission of the telecommand is verified to be a failure, the satellite telecommand transmitting apparatus may refer to retransmission information on each telecommand stored in the database and generate a retransmission telecommand with respect to the telecommand in operation 407.

Here, the satellite telecommand transmitting apparatus may detect, from the retransmission information on each telecommand, an additional telecommand associated with the telecommand and generate the retransmission telecommand including the telecommand and the detected additional telecommand. More particularly, the satellite telecommand transmitting apparatus may further detect, from the retransmission information on each telecommand, at least one piece of information on a transmission time of the additional telecommand based on the telecommand and a priority of the additional telecommand, determine a transmission order of the telecommand and the additional telecommand based on the detected information, arrange the telecommand and the additional telecommand based on the determined transmission order, and generate the retransmission telecommand.

When the telecommand or the additional telecommand associated with the telecommand is not detected from the retransmission information on each telecommand, the satellite telecommand transmitting apparatus may generate the telecommand as the retransmission telecommand.

In operation 409, the satellite telecommand transmitting apparatus may prepare or upgrade a retransmission command list including the generated retransmission telecommand and store the list in the database. When a type of the telecommand is a real time command, the satellite telecommand transmitting apparatus may add the retransmission telecommand with respect to the telecommand to the retransmission command list.

In operation 411, the satellite telecommand transmitting apparatus may verify whether all telecommands in the transmission command list are transmitted.

When all the telecommands in the transmission command list are determined not to be transmitted as a result of the verifying, the satellite telecommand transmitting apparatus may obtain a subsequent telecommand from the transmission command list. For example, when the first telecommand is transmitted in operation 403, the satellite telecommand transmitting apparatus may obtain a second telecommand in operation 413.

Subsequently, the satellite telecommand transmitting apparatus may continuously perform the operations 405, 407, 409, 411, and 413 until all the telecommands in the transmission command list are transmitted and thus, all the telecommands in the transmission command list may be all transmitted.

When all the telecommands in the transmission command list are determined to be transmitted as a result of the verifying in operation 411, the satellite telecommand transmitting apparatus may proceed to operation 415 and verify whether a retransmission command list is present in the database.

When the retransmission command list is present as a result of the verifying, the satellite telecommand transmitting apparatus may obtain the retransmission command list from the database in operation 417.

The satellite telecommand transmitting apparatus may return to operation 403 to obtain a first retransmission telecommand from the retransmission command list and transmit the obtained first retransmission telecommand to the satellite. Here, the satellite telecommand transmitting apparatus may transmit a telecommand and an additional telecommand included in the first retransmission telecommand to the satellite in an arranged order.

Subsequently, the satellite telecommand transmitting apparatus may continuously perform the operations 405, 407, 409, 411, and 413 until all retransmission telecommands in the retransmission command list are transmitted and thus, all the retransmission telecommands in the retransmission command list may be all transmitted.

According to exemplary embodiments of the present invention, a retransmission telecommand with respect to a telecommand failed to be transmitted to a satellite may be generated and added to a retransmission command list, and the retransmission telecommand in the retransmission command list may be transmitted after transmission of all telecommands is completed and thus, the telecommand failed to be transmitted to the satellite may be readily retransmitted.

According to exemplary embodiments of the present invention, transmission, verification, and retransmission of a telecommand may be automated by transmitting a telecommand, verifying whether transmission of the telecommand is successful, and generating and transmitting a retransmission telecommand with respect to the telecommand when a result of the verifying indicates a failure to transmit the telecommand. Thus, the telecommand failed to be transmitted to a satellite may be rapidly retransmitted.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A satellite telecommand transmitting apparatus, the apparatus comprising:
a transmitter to obtain a telecommand from a transmission command list and transmit the obtained telecommand to a satellite;
a verifier to verify whether transmission of the telecommand is successful; and
a processor to generate a retransmission telecommand with respect to the telecommand by referring to retransmission information on each telecommand stored in a database and prepare a retransmission command list comprising the generated retransmission telecommand, when a result of the verifying indicates a failure to transmit the telecommand.

2. The apparatus of claim 1, wherein the processor detects, from the retransmission information on each telecommand, an additional telecommand associated with the telecommand and generates the retransmission telecommand comprising the telecommand and the detected additional telecommand.

3. The apparatus of claim 2, wherein the processor further detects, from the retransmission information on each telecommand, at least one piece of information on a transmission time of the additional telecommand based on the telecommand and a priority of the additional telecommand, and
wherein the processor determines a transmission order with respect to the telecommand and the additional telecommand based on the detected information, and generates the retransmission telecommand by arranging the telecommand and the additional telecommand based on the determined transmission order.

4. The apparatus of claim 1, wherein when the telecommand or an additional telecommand associated with the telecommand is not detected from the retransmission information on each telecommand, the processor generates the telecommand as the retransmission telecommand.

5. The apparatus of claim 1, wherein when a type of the telecommand is a real time command, the processor adds the retransmission telecommand with respect to the telecommand to the retransmission command list.

6. The apparatus of claim 1, wherein when all telecommands comprised in the transmission command list are transmitted, the processor allows the retransmission telecommand comprised in the retransmission command list to be transmitted to the satellite by the transmitter.

7. The apparatus of claim 6, wherein the processor allows a telecommand and an additional telecommand comprised in the retransmission telecommand to be transmitted to the satellite based on a sequential order.

8. A satellite telecommand transmitting method, the method comprising:
obtaining a telecommand from a transmission command list and transmitting the obtained telecommand to a satellite;
verifying whether transmission of the telecommand is successful;
generating a retransmission telecommand with respect to the telecommand by referring to retransmission information on each telecommand stored in a database, when a result of the verifying indicates a failure to transmit the telecommand; and
preparing a retransmission command list comprising the generated retransmission telecommand.

9. The method of claim 8, wherein the generating comprises:
detecting an additional telecommand associated with the telecommand from the retransmission information on each telecommand; and
generating the retransmission telecommand comprising the telecommand and the detected additional telecommand.

10. The method of claim 9, wherein the generating comprises:
further detecting, from the retransmission information on each telecommand, at least one piece of information on a transmission time of the additional telecommand based on the telecommand and a priority of the additional telecommand; and
determining a transmission order with respect to the telecommand and the additional telecommand based on the detected information and generating the retransmission telecommand by arranging the telecommand and the additional telecommand based on the determined transmission order.

11. The method of claim 8, wherein the generating comprises:
generating the telecommand as the retransmission telecommand when the telecommand or an additional telecommand associated with the telecommand is not detected from the retransmission information on each telecommand.

12. The method of claim 8, wherein the preparing comprises:
adding the retransmission telecommand associated with the telecommand to the retransmission command list, when a type of the telecommand is a real time command.

13. The method of claim 8, further comprising:
transmitting the retransmission telecommand comprised in the retransmission command list to the satellite when all telecommands comprised in the transmission command list are transmitted.

14. The method of claim 13, wherein the transmitting comprises:
transmitting the telecommand and the additional telecommand comprised in the retransmission telecommand based on a sequential order.
